(19) United States
(12) Patent Application Publication
(10) Pub. No.: US 2007/0274402 A1
(43) Pub. Date: Nov. 29, 2007

(54) Application of short term and long term background scene dynamics in motion detection

(75) Inventors: M. Mohamad Ibrahim, Kayalpatnam (IN); Kwong Wing Au, Bloomington, MN (US)

Correspondence Address: Kris Fredrick;Honeywell International Inc., 101 Columbia Rd., P.O. Box 2245, Morristown, NJ, 07962, US

(73) Assignee: Honeywell International Inc.

(21) Appl. No.: 11/440,232

(22) Filed: May 23, 2006

(51) Int. Cl. H04B 1/66

(52) U.S. Cl. 375/240.29

(57) ABSTRACT

A method for motion detection includes capturing a plurality of frame images. The plurality of frame images is preprocessed. A first background reference is generated based on a first subset of the plurality of frame images. A second background reference is generated based on a second subset of the plurality of frame images, wherein the second subset of the plurality of frame images is a subset of the first subset of the plurality of frame images. A first motion result is generated based on the first background reference and a second motion result is generated based on the second background reference. The first motion result and the second motion result are combined to generate a combined result. Object motion is detected based on the combined result.

### TECHNICAL FIELD

Embodiments are generally related to the field of video image processing. Embodiments are additionally related to application of short-term and long-term background scene dynamics in motion detection.

### BACKGROUND OF THE INVENTION

Background subtraction is a popular method for motion detection, particularly where the background is static. In general, the background subtraction method (BSM) maintains a background reference and classifies pixels in a current frame by comparing them against the background reference. The background reference can be either a filtered image or a statistical image, such as, for example, the mean, variance, and/or median of pixel values.

Typical algorithms that use a background reference also require a learning period to generate the background reference. Further, during subsequent testing and/or segmentation phases, the background reference image and/or its statistics are updated with every incoming frame. Generally, the background learning scheme is expected to handle a wide variety of scenarios or scene dynamics. For example, the background learning scheme is expected to operate such that the motion detection on which it is based can detect moving objects with extreme speeds (e.g., people walking slowly, vehicles that start moving slowly near parking lots, fast moving objects on highways), objects that start moving from a stationary state (e.g., a parked car that starts moving after the learning period), and moving objects halting and becoming part of the background.

Correctly identifying moving objects depends on correctly identifying whether changes in the image are attributable to the non-static background or to a moving object, even if the moving object was itself part of the background. Therefore, accurate background information is critical in dealing with these diverse scene dynamics. Typical background learning or modeling schemes cannot quickly respond to the above changes in the background reference. In other words, a single background model used in the prior image captures experiences scene changes over its entire past history at a fixed rate and hence does not reflect scene dynamics changing at other rates.

Moreover, image processing generally is a computationally intensive task. While complicated background reference modeling schemes have been developed that provide some improvements in responding to complex scene dynamics, these schemes require intense computations well beyond the limited computational power of readily available real-time processing systems. Better simple background references and background learning models are needed to accurately model the diverse scene dynamics.

Therefore, what is required is a system, apparatus, and/or method that provides an improved response to diverse scene dynamics that overcomes at least some of the limitations of previous systems and/or methods.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved background learning scheme.

It is a further aspect of the present invention to provide for an improved motion detection system.

It is a further aspect of the present invention to provide for an improved image processing system.

The aforementioned aspects and other objectives and advantages can now be achieved as described herein. A method for motion detection includes capturing a plurality of frame images. The plurality of frame images is preprocessed. A first background reference is generated based on a first subset of the plurality of frame images. A second background reference is generated based on a second subset of the plurality of frame images, wherein the second subset of the plurality of frame images is a subset of the first subset of the plurality of frame images. A first motion result is generated based on the first background reference and a second motion result is generated based on the second background reference. The first motion result and the second motion result are combined to generate a combined result. Object motion is detected based on the combined result.

In an alternate embodiment, a system for motion detection includes an image capture module configured to capture a plurality of frame images. A preprocessor is coupled to the image capture module and configured to preprocess the plurality of frame images. A long-term background reference is based on a first subset of the plurality of frame images and a short-term background reference is based on a second subset of the plurality of frame images, wherein the second subset of the plurality of frame images is a subset of the first subset of the plurality of frame images. A long-term motion detector is configured to generate a first motion result based on the long-term background reference and a short-term motion detector is configured to generate a second motion result based on the short-term background reference. A combiner is configured to generate a combined result based on the first motion result and the second motion result. A motion detector is configured to detect object motion based on the combined result.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram showing an illustrative video image processing system in accordance with a preferred embodiment;

FIG. 2 illustrates a block diagram of a short-term and long-term background modeling and motion detection system in accordance with a preferred embodiment;

FIG. 3 illustrates a block diagram of software modules of the motion detection system in accordance with a preferred embodiment; and

FIG. 4 illustrates a high-level flow chart depicting logical operational steps in learning short-term and long-term backgrounds, which may be implemented in accordance with a preferred embodiment.

### DETAILED DESCRIPTION

The particular values and configurations discussed in these non-limiting examples can be varied and are cited merely to illustrate at least one embodiment and are not intended to limit the scope of the invention.

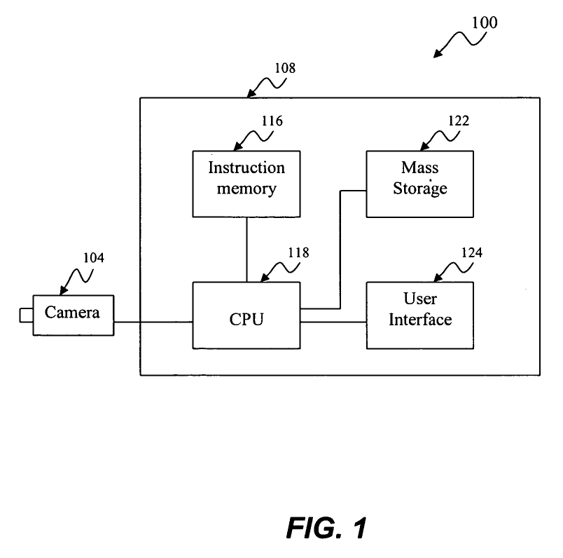

FIG. 1 is a high-level block diagram illustrating certain components of a system 100 for motion detection in video images, in accordance with a preferred embodiment of the present invention. The system 100 comprises one or more cameras 104 that output digital images of one or more background areas in a digital data stream. In the illustrated embodiment, only one camera 104 is shown. Each camera 104 sends a video feed to a processing system 108. In the illustrated embodiment, a single processing system 108 is shown. One skilled in the art will understand that system 100 can also include a plurality of processing systems 108, each associated with a particular camera 104.

Processing system 108 includes an instruction memory 116 for storing and providing software instructions to a central processing unit (CPU) 118 for execution. The central processing unit 118 operates on the digital data stream from camera 104 in accordance with the software instructions, so as to analyze the incoming images to produce useful results (such as, for example, detecting a moving object in the scene). Processing system 108 further includes a mass storage device 122, such as, for example, a hard disk, for storing the raw video images from camera 104 and/or the output information or processed video images from CPU 118. In addition, there is a user interface 124 so that an operator may interact with the system. For instance, the user interface typically may comprise a computer monitor, keyboard, and/or computer mouse device.

In a preferred embodiment, the invention is implemented in software. However, this is not a limitation of the invention and the invention can be implemented in any reasonable fashion, including firmware, digital signal processors, ASIC hardware, software, or combinations of any or all of the above.

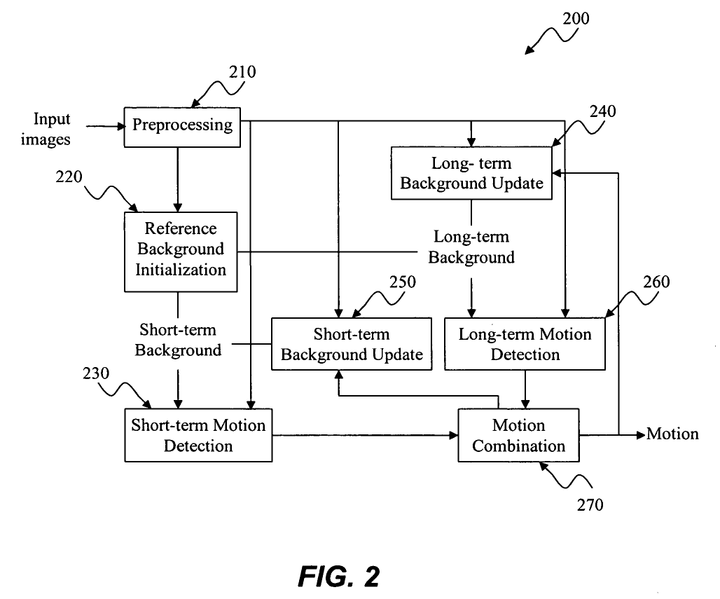

With reference now to FIG. 2, there is illustrated a block-diagram representation 200 of the software configuration of processing system 108 of FIG. 1. For ease of illustration, high-level software/hardware functionality is described in terms of modules and/or processors. One skilled in the art will understand that one or more of software, hardware, or a combination of the two can be employed to provide the depicted functionality, as described in more detail below. Generally, processing system 108 operates as follows. Input images captured by the camera are sent to preprocessor 210. Preprocessor 210 prepares the received images for background modeling and motion detection, as described in more detail below, generating a plurality of preprocessed images. Upon the start of the motion detection process, a first plurality of the preprocessed images is sent to the Reference Background Initialization module 220, which generates, or “learns,” the short-term background 222 and the long-term background 224, as described in more detail below.

Having learnt the backgrounds, the motion detection system sends subsequent preprocessed images to the Short-term Motion Detection module 230 and Long-term Motion Detection module 260. Short-term Motion Detection module 230 determines object movement in fast changing scene dynamics based on comparison with the short-term background 222. Long-term Motion Detection module 260 determines object movement in slowly changing scene dynamics based on comparison with the long-term background 224.

Motion Combination module 270 resolves any conflicts and combines the short-term motion detection and long-term motion detection results. The combined short-term and long-term motion detection results yield all the object motion in the image. The Short-term Background Update module 250 re-estimates the short-term background 222 based on the preprocessed image and the combined motion analysis. Similarly, the Long-term Background Update 240 re-estimates the long-term background 224 based on the preprocessed image and the combined motion analysis. The updated short-term and long-term backgrounds 222 and 224 are then used for comparison with the next preprocessed image.

In a preferred embodiment, the invention uses a short-term background and a long-term background to respond to both fast and slow scene dynamics. In other embodiments, additional reference backgrounds can also be estimated, updated and used to detect motion at various degrees of change in scene dynamics. For example, a short-term, a medium-term and a long-term background can be used to capture three ranges of scene dynamic changes. One skilled in the art will understand that other configurations can also be employed.

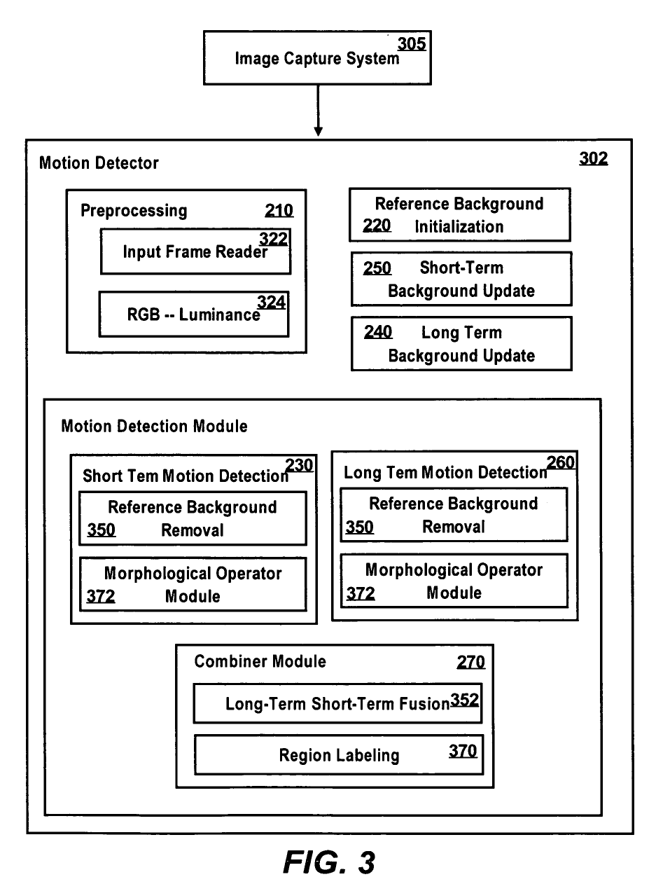

With reference now to FIG. 3, there is illustrated a modular representation of a preferred embodiment of the software configuration of motion detection system 100 of FIG. 1. Generally, the reference numeral 300 refers to a motion detection system. Motion detection system 300 includes motion detector 302 and image capture system 305. Generally, image capture system 305 is a conventional image capture system and can include, for example, one or more cameras, whether remote or local, analog or digital, one or more image processors configured to store and/or convert captured images, and so forth, as one skilled in the art will understand. In one embodiment, image capture system 305 is resident in camera 104 of FIG. 1. In an alternate embodiment, image capture system 305 is resident in CPU 118 and/or system 108 and coupled to camera 104 of FIG. 1.

As illustrated, system 300 includes motion detector 302. Motion detector 302 includes preprocessing module 210, motion detection module 215, Reference Background initialization module 220, short-term background update module 250 and long-term background update module 240, which are configured as described below.

In general, motion detector 302 receives input from image capture system 305. One skilled in the art will understand that input from image capture system 305 can include a plurality of frame images in a sequence and in a variety of formats. In a preferred embodiment, the frame images of the plurality of sequential frame images are all in the same format. As illustrated, motion detector 302 includes preprocessing module 210. In the illustrated embodiment, preprocessing module 210 comprises input image reader 322 and RGB to Luminance module 324.

In a preferred embodiment, input image reader 322 receives one frame image at a time of the plurality of sequential frame images received from image capture system 305. In an alternate embodiment, input image reader 322 receives a plurality of frame images of the plurality of sequential frame images received from image capture system 305, and reads the received plurality of frame images one at a time. In one embodiment, input image reader 322 is configured to convert received frame images from a camera format to a local computer format based on the particular software and/or operating system of motion detector 302. In a preferred embodiment, input image reader 322 loads the received frame image as the current frame image, frame(t).

In general, the current frame image includes RGB (red, green, blue) data that describes the frame image. One skilled in the art will understand that RGB data can comprise a specified, predetermined standard format. RGB to Luminance module 324 converts the RGB data of the current frame image to luminance data. One skilled in the art will understand that luminance data can comprise a specified, predetermined standard format. In one embodiment, luminance data is a weighted sum of the RGB data in a particular direction. One skilled in the art will understand that other configurations can also be employed.

Furthermore, in an alternate embodiment, the remaining processing of frame images to detect motion and create reference backgrounds can be configured to employ the RGB data instead of luminance data. In an alternate embodiment, RGB to Luminance module 324 can be configured to convert other data types, such as, for example, CMYK (cyan, magenta, yellow, black), or other suitable data type, to luminance data. Generally, the luminance data is used by other modules in motion detector 302 as described below.

Additionally, in an alternate embodiment, preprocessing module 210 can include other image processing function modules, such as noise filtering, sub-sampling, and stabilization alignment, as one skilled in the art will understand. These additional functions, among others, can be employed to reformat, resize, smooth and realign the input images.

One way motion detector 302 uses the preprocessed data is used is to update a long-term background reference 240. In one embodiment, a long-term background reference 240 is generated through an application of a recursive filter formula to the preprocessed data. In one preferred embodiment, the formula is:

LongTermBackground(t+1)=α*frame(t)+(1−α)*LongTermBackground(t)

Where LongTermBackground(t) is the long-term background reference model (LTBG) at time t, α (alpha) is the recursive factor (which has a value >=0 and <=1.0), and frame(t) is the preprocessed image frame at time t. One skilled in the art will understand that the frame image can comprise a plurality of pixels.

In another embodiment, the long-term background reference 240 is generated through applied pixel-based recursive filter formulae. These formulae are:

### If motion is not detected at pixel location x,y, then

LTBackgroundPixel(x,y,t+1)=α*framePixel(x,y,t)+(1−α)*LTBackgroindPixel(t)

### If motion is detected at pixel location x,y, then

LTBackgroundPixel(x,y,t+1)=β*framePixel(x,y,t)+(1−β)*LTBackgroundPixel(t)

Where LTBackgroundPixel(x,y,t) is the pixel of the long-term background reference model at coordinate (x,y) at time t and α and β are the recursive update rates. That is, in a preferred embodiment, the pixels of the long-term background model are updated at two different rates, depending on whether the pixel is detected as part of a moving object or not.

Generally, short-term background (STBG) reference 250 is a background model generated based on a subset of the current and m previously processed frame images, which are saved in a circular buffer (not shown in FIG. 3). In a preferred embodiment, STBG reference 250 is generated based on a median value at each pixel location, or “median model,” from the buffered preprocessed data. In an alternate embodiment, STBG reference 250 is generated based on an average model of the buffered frame image data. In one embodiment, STBG reference 250 is based on the ten most-recently processed frame images. That is, m=10.

Motion detector 302 also includes short-term motion detection module 230 and long-term motion detection module 260, both of which include reference background removal module 350 and morphological operator module 372, and which use the STBG model and LTBG model respectively. Generally, as used herein, reference background removal is any number of techniques well known to those skilled in the art for removing the static background pixels based on comparison between a reference background and the preprocessed image, as one skilled in the art will understand. In a preferred embodiment, reference background removal 350 first computes the absolute of the difference between the reference background and the preprocessed image. Then an adaptive threshold is applied to differentiate between background and non-background pixels.

Generally, morphological operations module 372 is configured to perform morphological operations on a background reference. One skilled in the art will understand that morphological operations can include any number of well known image manipulation functions based on shapes, including dilation and erosion, among others. One skilled in the art will also understand that other image processing operations in addition to, or instead of, reference background removal and morphological operations can also be employed.

Motion Detection module 215 also includes combiner module 270. Combiner module 270 takes the results of the motion detection of short-term motion detection module 230 and long-term motion detection module 260 and generates a motion image. In one embodiment, the long-term, short term fusion module 352 combines the motion detection results through a logical operation, such as a logic “AND” or “OR” operation. In a generalized embodiment, the long-term, short-term fusion module 352 combines the short-term and long-term motion detection results using a majority m out of n rule. One skilled in the art will understand that other configurations, such as, for example, a weighed sum, can also be employed.

Further, in the illustrated embodiment, the combined result generated by long-term, short-term fusion module 352 is also modified by region labeling module 370. Generally, region labeling module 370 is configured to perform region identification and labeling on the combined result. One skilled in the art will understand that region identification and labeling can include identifying a number of contiguous regions in an image, and a determination as to what region, if any, each individual pixel belongs.

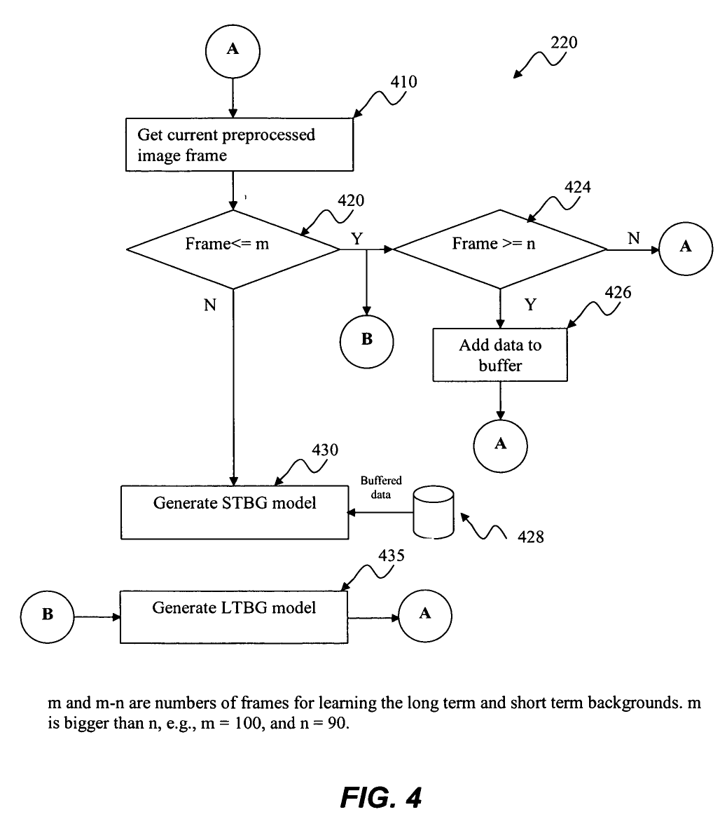

Referring now to FIG. 4, there is illustrated a high-level flow chart 400 that depicts logical operational steps for reference background initialization as performed by, for example, reference background initialization module 220 of FIG. 3, which may be implemented in accordance with a preferred embodiment. As indicated at block 405, the process begins, wherein a series of images is captured. This operation can be performed by, for example, image capture system 305 of FIG. 3. As indicated next at block 410, a preprocessed frame image of the series of captured images is read as the “current frame image.”

Next, as illustrated at decisional block 420, a determination is made whether the current frame is the m^{th} or earlier frame image processed. In one embodiment, m equals 100. If it is determined that the current frame is the m^{th} or earlier frame image processed, then the process continues along the YES branch to marker “B.” As illustrated at block 435, the current frame is used to generate a long-term background reference and the process returns to marker “A.” As illustrated, the process then returns to the operation depicted at block 410, wherein the next frame image is read as the current frame image.

Additionally, if it is determined that the current frame is the m^{th} or earlier frame image processed, then the process also continues along the YES branch to block 424. Next, as illustrated at decisional block 424, a determination is made whether the current frame is the n^{th} or later frame image processed, where in one embodiment n is equal to 90.

If it is determined that the current frame is the n^{th} or later frame image processed, then the process continues along the YES branch and the frame image data is added to a buffer, as described at block 426. The process then returns to the operation depicted at block 410, wherein the next frame image is read as the current frame image. If, in the operation depicted at decisional block 424, it is determined that the current frame is not the n^{th} or later frame image processed, then the process continues along the NO branch and returns to the operation depicted at block 410, wherein the next frame image is read as the current frame image.

If, in the operation depicted at decisional block 420, it is determined that the current frame is not the m^{th} or earlier frame image processed, then a short-term background (STBG) model is generated, as depicted at block 430. This operation can be performed by, for example, short-term background update 250 of FIG. 2. As described above, this operation can include employing buffer 428 to short-term background update 250 of FIG. 2. Thereafter, the process returns to marker “A” and the operation depicted at block 410, wherein the next frame image is read as the current frame image.

Accordingly, the embodiments provide for a motion detection system, apparatus, and method for improved background generation and learning in motion detection. In particular, the combination of both “long-term” and “short-term” scene dynamics provides a background learning scheme that is more flexible, while remaining uncomplicated as compared to previous systems and methods. Further, the improved background generation allows improved measurement and detection of both fast- and slowly-changing scene dynamics and elements in a motion detection system.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method for motion detection, comprising:
capturing a plurality of frame images;
preprocessing the plurality of frame images;
generating a first background reference based on a first subset of the plurality of frame images;
generating a second background reference based on a second subset of the plurality of frame images;
wherein the second subset of the plurality of frame images is a subset of the first subset of the plurality of frame images;
generating a first motion result based on the first background reference;
generating a second motion result based on the second background reference;
combining the first motion result and the second motion result to generate a combined result; and
detecting object motion based on the combined result.

2. The method of claim 1, wherein the first background reference is a long-term background reference and the second background reference is a short-term background reference.

3. The method of claim 1, further comprising:
generating a third background reference based on a third subset of the plurality of frame images, wherein the third subset of the plurality of frame images is a subset of the first subset of the plurality of frame images;
generating a third motion result based on the third background reference; and
combining the first motion result, the second motion result and the third motion result to generate the combined result.

4. The method of claim 1, wherein the first background reference is generated through a set of pixel-based recursive filter formulae.

5. The method of claim 1, wherein the second background reference is generated through an average model of mean pixel data.

6. The method of claim 1, wherein preprocessing comprises converting RGB data to luminance data.

7. The method of claim 1, wherein combining comprises fusion of the first motion result and the second motion result to generate a fused result, and region labeling of the fused result to generate the combined result.

8. The method of claim 1, wherein generating the first motion result and the second motion result comprises reference background removal and morphological operations.

9. A system for motion detection, comprising:
an image capture module configured to capture a plurality of frame images;
a preprocessor coupled to the image capture module and configured to preprocess the plurality of frame images;
a long-term background reference based on a first subset of the plurality of frame images;
a short-term background reference based on a second subset of the plurality of frame images;
wherein the second subset of the plurality of frame images is a subset of the first subset of the plurality of frame images;
a long-term motion detector configured to generate a first motion result based on the long-term background reference;
a short-term motion detector configured to generate a second motion result based on the short-term background reference;
a combiner configured to generate a combined result based on the first motion result and the second motion result; and
a motion detector configured to detect object motion based on the combined result.

10. The system of claim 9, further comprising an updater configured to modify the long-term background reference and the short-term background reference based on the combined result.

11. The system of claim 9, wherein the long-term background reference is generated through a set of pixel-based recursive filter formulae.

12. The system of claim 9, wherein the short-term background reference is generated through an average model of mean pixel data.

13. The system of claim 9, wherein the combiner is configured to fuse the first motion result and the second motion result to generate a fused result, and to perform region labeling of the fused result to generate the combined result.

14. A computer program product for motion detection, the computer program product having a computer-readable medium with a computer program embodied thereon, the computer program comprising:
computer code for capturing a plurality of frame images;
computer code for preprocessing the plurality of frame images;
computer code for generating a first background reference based on a first subset of the plurality of frame images;
computer code for generating a second background reference based on a second subset of the plurality of frame images;
computer code for wherein the second subset of the plurality of frame images is a subset of the first subset of the plurality of frame images;
computer code for generating a first motion result based on the first background reference;
computer code for generating a second motion result based on the second background reference;
computer code for combining the first motion result and the second motion result to generate a combined result; and
computer code for detecting object motion based on the combined result.

15. The computer program of claim 14, wherein the first background reference is a long-term background reference and the second background reference is a short-term background reference.

16. The computer program of claim 14, further comprising:
computer code for generating a third background reference based on a third subset of the plurality of frame images, wherein the third subset of the plurality of frame images is a subset of the first subset of the plurality of frame images;
computer code for generating a third motion result based on the third background reference; and
computer code for combining the first motion result, the second motion result and the third motion result to generate the combined result.

17. The computer program of claim 14, wherein the first background reference is generated through a set of pixel-based recursive filter formulae.

18. The computer program of claim 14, wherein the second background reference is generated through an average model of mean pixel data.

19. The computer program of claim 14, wherein combining comprises fusion of the first motion result and the second motion result to generate a fused result, and region labeling of the fused result to generate the combined result.

20. The computer program of claim 14, wherein generating the first motion result and the second motion result comprises reference background removal and morphological operations.
